(19) United States
(12) Patent Application Publication
(10) Pub. No.: US 2024/0361499 A1
(43) Pub. Date: Oct. 31, 2024

(54) THERMAL LENS SET, USE OF THERMAL LENS SET AND METHOD TO REMOVE MIST FROM LENS SET

(71) Applicant: Eterge Opto-Electronics Co., Ltd., Taichung City (TW)

(72) Inventors: Chih-Cheng Hsu, Taichung City (TW); Tsu-Meng Lee, Taichung City (TW); Yun-Xian Li, Taichung City (TW)

(21) Appl. No.: 18/372,143

(22) Filed: Sep. 25, 2023

Related U.S. Application Data
(60) Provisional application No. 63/462,521, filed on Apr. 27, 2023.

(30) Foreign Application Priority Data
Aug. 2, 2023 (TW) 112129050

(51) Int. Cl. G02B 3/00; G02B 13/00; G03B 11/04; G03B 17/12; G03B 17/56

(52) U.S. Cl. CPC G02B 3/0062; G02B 13/0015; G03B 11/041; G03B 17/12; G03B 17/565

(57) ABSTRACT

A thermal lens set includes an imaging lens group including an inner lens group and an outer lens group. The outer lens group includes at least one outer lens element. A heater is used to heat the imaging lens group and includes at least two portions. One of the at least two portions is in direct contact with the imaging lens group. A lens barrel is used to accommodate another one of the at least two portions.

### CROSS REFERENCE TO RELATED APPLICATIONS

This application claims the benefit of U.S. Provisional Application No. 63/462,521, filed on Apr. 27, 2023. The content of the application is incorporated herein by reference.

### BACKGROUND OF THE INVENTION

### 1. Field of the Invention

The present invention generally relates to a thermal lens set and use of a thermal lens set, and in particular the present invention is directed to a thermal lens set to remove a mist from an imaging lens set and use of the thermal lens set.

### 2. Description of the Prior Art

Influence of ambient temperature on optical imaging lens varies from environmental tolerance of lens material at different temperature conditions. For example, in the case of an outdoor-used optical imaging lens, such as vehicle imaging lens, sport camera lens, or aerial camera lens, etc., several glass lenses are usually required to reduce the effect of temperature changes on the shape of the lens to provide stable imaging quality. On the contrary, in the case of an indoor-used optical imaging lens, such as home surveillance camera lens, since the indoor environment is usually maintained at a temperature range, plastic lenses could be used to replace glass lenses to reduce the manufacture cost and weight of the optical imaging lens.

In addition, when the optical imaging lens is used in an environment with a large temperature difference, such as moving from outdoor into indoor, or in a damp and cold weather, moisture in the air is easily condensed onto the lens surface of the optical imaging lens to form fog or frost, which affect the clarity of the image. However, the consumer is not easy to solve the fogging or frosting phenomenon of the optical imaging lens since each piece of the optical lenses is precisely set when the optical imaging lens is assembled.

At present, most of the optical imaging lens with defogging or defrosting function using sensing chip (NTC or PTC) are set on the heating element or in an exposed environment, which will not only easily cause inaccurate sensing, but may even cause damage to the NTC.

Therefore, it is an object for the persons of the technical field to provide an optical imaging lens with defogging or defrosting function.

### SUMMARY OF THE INVENTION

In view of these, the present invention provides a thermal lens set to use a heater therein to heat an imaging lens group, so it may avoid the problem which makes a general optical lens out of order as the field of view of the general optical lens is prone to being blocked due to frosting and icing in cold regions or in a snowy winter.

In order to solve the above problem, the present invention provides an optical imaging lens including:
an optical lens group, including a plurality of optical lens;
a lens barrel, including an outer wall surface and an inner wall surface, the outer wall has a flange, the optical lens group is disposed in the lens barrel in order from an object side to an image side, and the outer wall surface has a storage space or the flange has a storage space;
a heating element is arranged between at least one optical lens and the lens barrel;
a sealing element is arranged between the heating element and the lens barrel;
a conductive element, one end of which is connected to the heating element and the other end is connected to a power supply source, and
a sensing chip is arranged on the conductive element and may be put into the storage space.

One objective of the present invention is to provide a thermal lens set. The thermal lens set of the present invention includes an imaging lens group, a heater and a lens barrel. The imaging lens group includes an inner lens group and an outer lens group. The outer lens group includes at least one outer lens element. The heater is used to heat the imaging lens group and includes at least two portions. One of the at least two portions is in direct contact with the imaging lens group. The lens barrel is used to accommodate another one of the at least two portions.

According to one example of the present invention, the at least two portions of the heater include a non-thermal zone and a thermal zone with a heating element.

According to another example of the present invention, the at least one outer lens element is in direct contact with the heating element.

According to another example of the present invention, the inner lens group includes a plurality of inner lens elements and the heating element is disposed between the outer lens group and the inner lens group.

According to another example of the present invention, a shape of the thermal zone is selected from a group consisting of an annular shape and a crescent shape.

According to another example of the present invention, the at least two portions of the heater includes a plurality of thermal zones including a plurality of heating elements.

According to another example of the present invention, the thermal lens set further includes a sensor disposed in the non-thermal zone and electrically connected to the heating element.

According to another example of the present invention, the lens barrel includes a body including a space to accommodate the sensor.

According to another example of the present invention, the lens barrel includes a flange including a space to accommodate the sensor.

According to another example of the present invention, the lens barrel includes a seal ring disposed between the outer lens group and the inner lens group.

According to another example of the present invention, the lens barrel includes a seal ring disposed between the heating element and the inner lens group.

According to another example of the present invention, the thermal lens set further includes a cap to accommodate the at least one outer lens element.

According to another example of the present invention, the sensor is a thermistor.

According to another example of the present invention, the sensor is a surface mount device (SMD).

According to another example of the present invention, the heating element has an outer diameter D1 and an inner diameter D2, and (D1−D2)/2≥0.8 mm.

According to another example of the present invention, a temperature difference between the thermal zone and the non-thermal zone is not less than 40° C. after 1 minute of activating the heating element.

According to another example of the present invention, a temperature difference between the outer lens group and the inner lens group is not less than 20° C. after 1 minute of activating the heating element.

Another objective of the present invention is to provide use of a thermal lens set. First, the above-described thermal lens set is provided. The heater includes a non-thermal zone and a thermal zone with a heating element. Then, the heater is activated so that a temperature difference between the non-thermal zone and the thermal zone is not less than 40° C. after 1 minute of the activation of the heating element.

Another objective of the present invention is to provide a method to remove a mist from a lens set. First, the above-described thermal lens set is provided. The heater includes a non-thermal zone and a thermal zone which includes a heating element in direct contact with the outer lens group which has a mist thereon. Then, the heater is activated so that a temperature difference between the outer lens group and the inner lens group is not less than 20° C. to at least partially remove the mist after 1 minute of the activation of the heating element.

According to another example of the present invention, the heater includes a sensor and the lens barrel includes a space to accommodate the sensor which determines the temperature difference.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exploded view of a first embodiment of the thermal lens set of the present invention.

FIG. 2A to FIG. 2D are diagrams to illustrate various embodiments of the thermal zone of the heater according to the present invention.

FIG. 2E to FIG. 2H are schematic diagrams of some variant embodiments of the thermal zone and the non-thermal zone of the heater according to the present invention.

FIG. 3 illustrates an exploded view of components of a second embodiment of the thermal lens set of the present invention.

FIG. 4 illustrates an exploded view of components of a third embodiment of the thermal lens set of the present invention.

### DETAILED DESCRIPTION

The thermal lens sets of the present invention are described below in conjunction with specific embodiments and drawings of the present invention. However, the specific embodiments and drawings of the present invention are used to depict the gist of the present invention and make it easier to understand, and are not intended to limit the scope of the claims of the present invention.

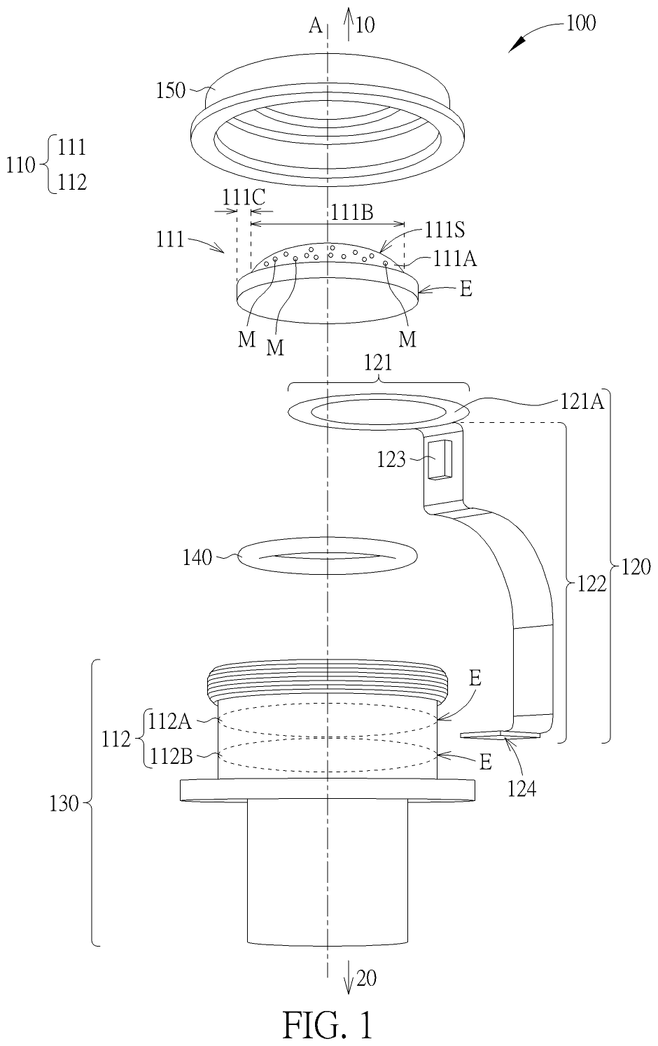

FIG. 1 illustrates an exploded view of a first embodiment of the thermal lens set of the present invention. Please refer to FIG. 1. The thermal lens set 100 of the present invention includes an imaging lens group 110, a heater 120 and a lens barrel 130. The imaging lens group 110 includes an outer lens group 111 and an inner lens group 112. The imaging lens group 110 has an optical axis A, an aperture (not shown), a filter (not shown), an image plane (not shown), a first side 10 and a second side 20. The optical axis A passes through the first side 10, the aperture (not shown), the outer lens group 111, the inner lens group 112, the filter (not shown), the image plane (not shown), the heater 120, the lens barrel 130 and the second side 20. The first side 10 and the second side 20 respectively face different directions. For example, the first side 10 is an object side where an object (not shown) is located, and the second side 20 is an image side where the image plane (not shown) is located.

The outer lens group 111 includes at least one outer lens element, such as a first outer lens element 111A, but the present invention is not limited thereto. The inner lens group 112 includes a plurality of inner lens elements, such as a first inner lens element 112A and a second inner lens element 112B, but the present invention is not limited thereto. Any lens element in the outer lens group 111 or in the inner lens group 112, taking the first outer lens element 111A shown in FIG. 1 as an example, sequentially includes an optical effective region 111B and an edge region 111C from the optical axis A to the edge E. The optical axis A penetrates the optical effective region 111B, and the edge region 111C surrounds the optical effective region 111B. In one embodiment of the present invention, the edge E surrounds the optical effective region 111B. Taken the first outer lens element 111A as an example, FIG. 1 shows that the edge E surrounds the optical effective region 111B.

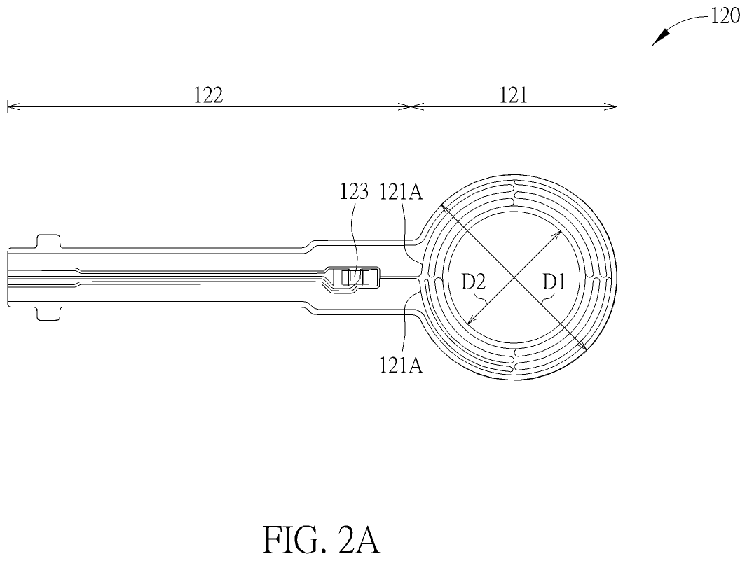

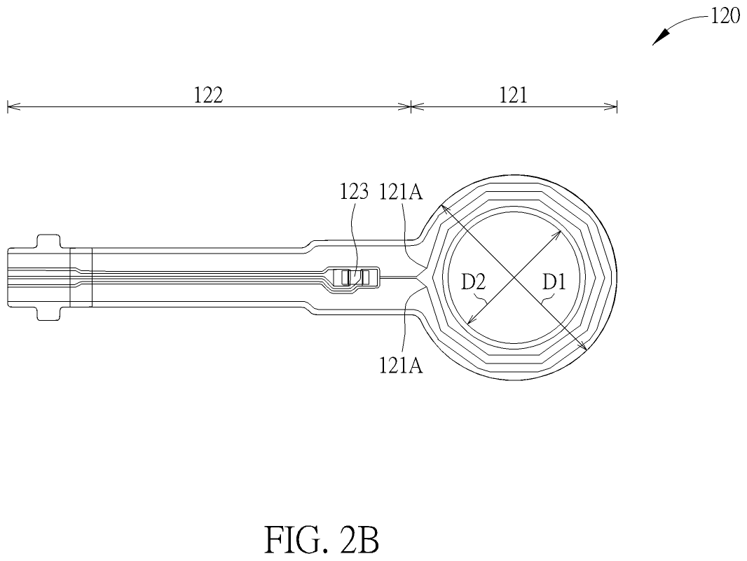

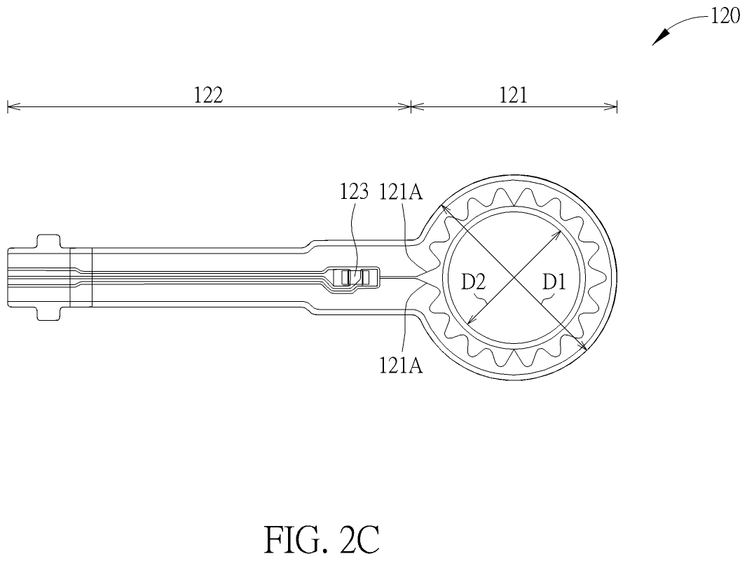

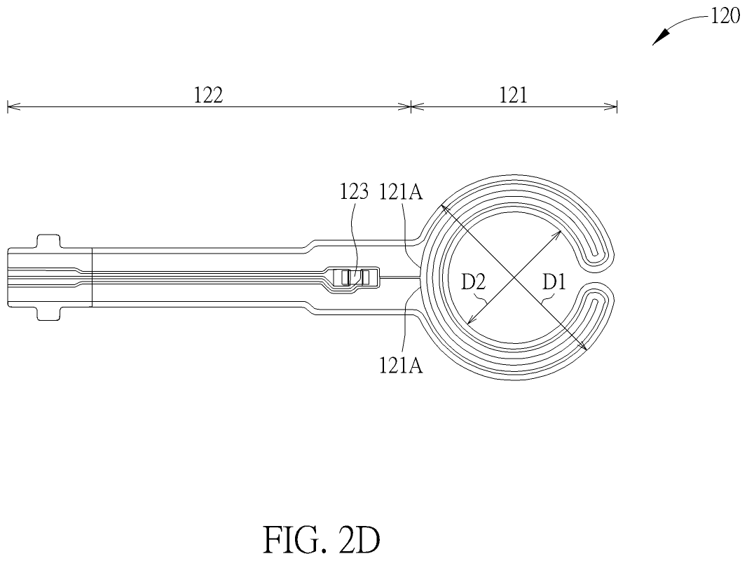

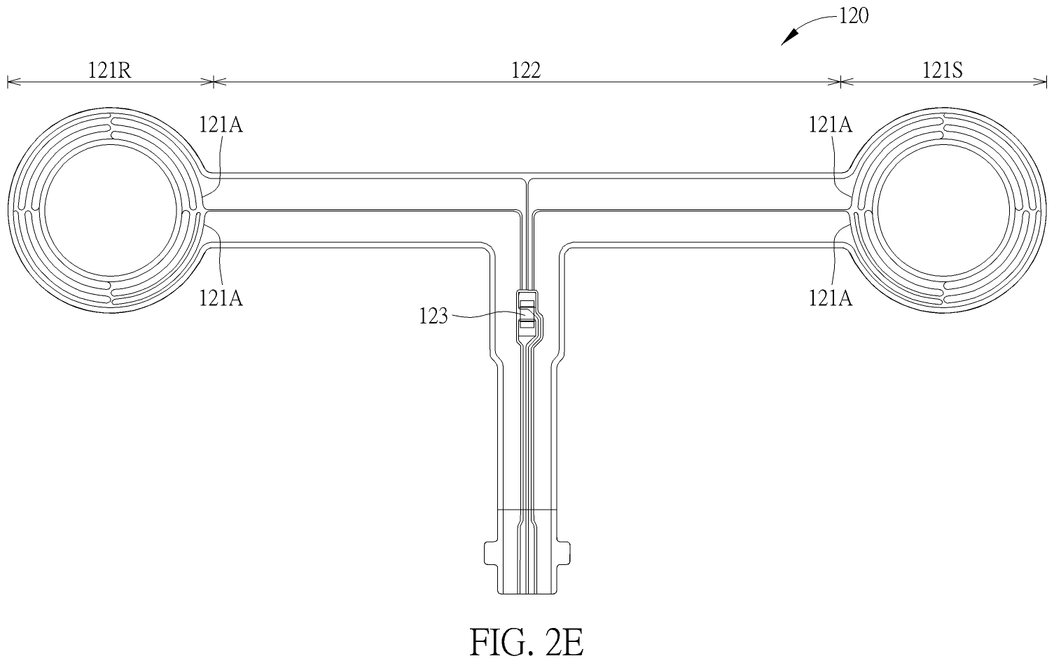

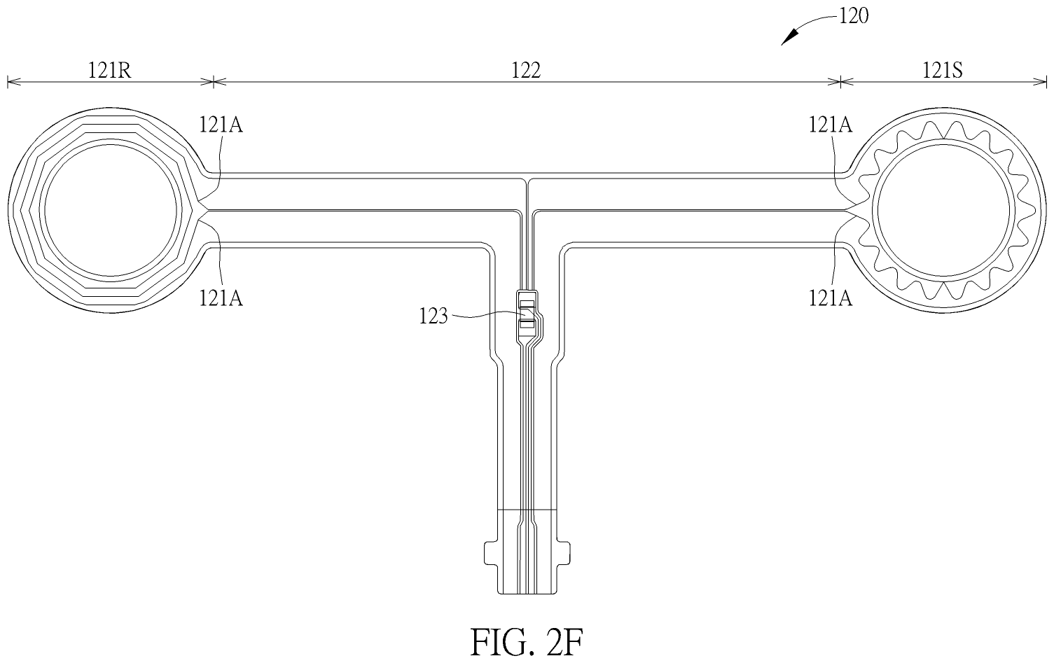

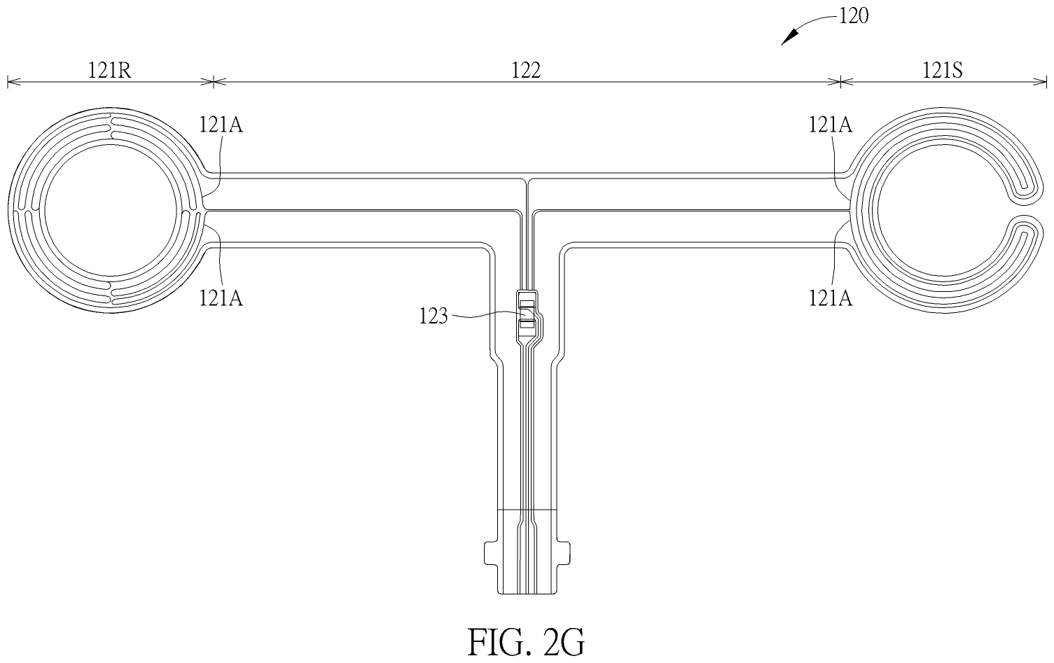

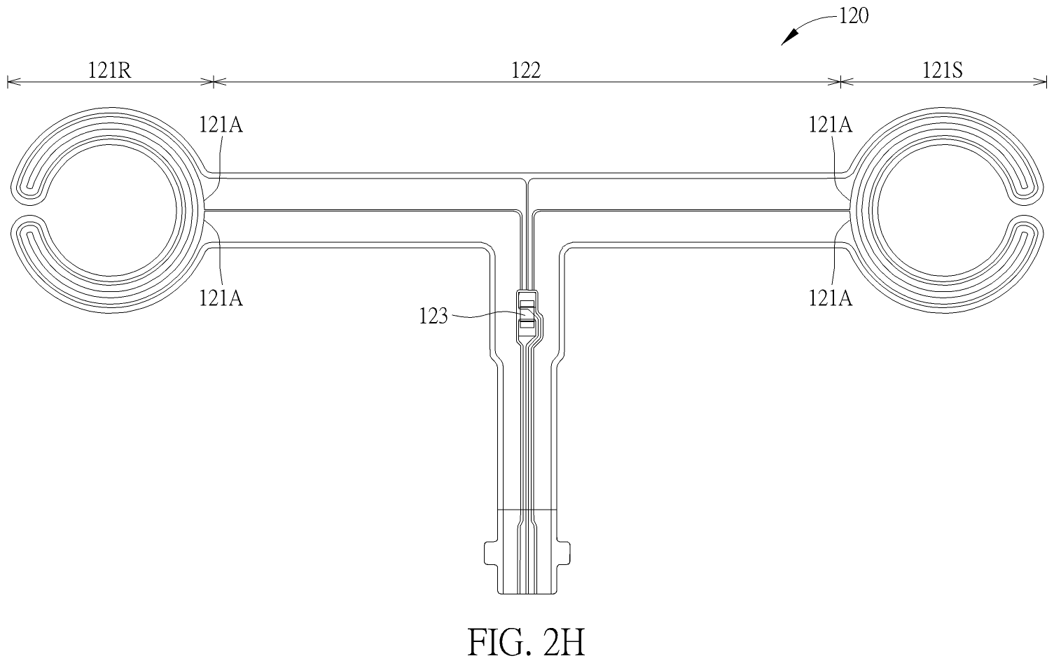

The heater 120 is used to heat the lens elements in the imaging lens group 110, such as the first outer lens element 111A, but the present invention is not limited thereto. The heater 120 includes at least two portions, such as a thermal zone 121 and a non-thermal zone 122, but the present invention is not limited thereto. One of the thermal zone 121 and the non-thermal zone 122 is in direct contact with the imaging lens group 110, such as the heating element 121A in the thermal zone 121 (shown in FIG. 2A to FIG. 2D) is in direct contact with the lens elements in the imaging lens group 110, such as the first outer lens element 111A, so as to directly transfer the heat energy generated by the heating element 121A (shown in FIG. 2A to FIG. 2D) in the thermal zone 121 to the first outer lens element 111A, but the present invention is not limited thereto. The non-thermal zone 122 further has a terminal 124 to serve as a contact point for electrically connecting the heating element 121A of the heater 120 with an external power supply device (not shown). In one embodiment of the present invention, the heating element 121A (shown in FIG. 2A to FIG. 2D) of the thermal zone 121 is disposed between the outer lens group 111 and the inner lens group 112.

FIG. 2A to FIG. 2D are schematic diagrams to illustrate various embodiments of the thermal zone 121 of the heater 120 according to the present invention. The thermal zone 121 of the heater 120 of the present invention includes a heating element 121A. The heating element 121A may be designed to match possible shapes, such as a annular shape or a crescent shape, of the thermal zone 121 and the edge zone 111C (shown in FIG. 1) so as to avoid blocking the optical effective zone 111B. The outer diameter of the thermal zone 121 of the annular or crescent heater 120 is D1, and the inner diameter of the thermal zone 121 of the heater 120 is D2. In one embodiment of the present invention, (D1−D2)/220.8 mm. In another embodiment of the present invention, a low-power of low-voltage external power supply may be used for heating, such as 5 V/1 W, when the value of (D1−D2)/2 is between 0.8 mm and 1.1 mm. In yet another embodiment of the present invention, a high-power of high-voltage external power supply, such as 12 V/3 W, may be used for heating, when the value of (D1−D2)/2 is greater than 1.1 mm.

For example, please refer to FIG. 2A, the shape of the thermal zone 121 of the heater 120 may be annular. The resistors in the annular ring may be designed to be tortuous to match the annular thermal zone 121. Such design is beneficial to increase the length of the resistors, so as to improve the instantaneous thermal efficiency of the heater 120 in a cold environment.

Or, please refer to FIG. 2B, the shape of the thermal zone 121 of the heater 120 may be annular. The resistors in the annular ring may be designed to be annular to match the annular thermal zone 121. Such design is beneficial to simplify the layout pattern of the resistors.

Alternatively, please refer to FIG. 2C, the shape of the thermal zone 121 of the heater 120 may be annular. The resistors in the annular ring may be designed to be wavy to match the annular thermal zone 121. Such design is beneficial to increase the contact region between the heat-generating region and the outer lens group, so as to make the heat conduction efficiency better.

Or, please refer to FIG. 2D, the shape of the thermal zone 121 of the heater 120 may be crescent, such as a double crescent shape. The resistors in the double-crescent shape may be designed to be tortuous U shape to match the double-crescent-shaped thermal zone 121. The design of the double crescent-shaped thermal zone 121 is beneficial to increase the design flexibility of the thermal zone 121.

The sensor 123 is, for example, a thermistor. The thermistor is a thermal type resistor. This kind of electronic component responds by changing its resistance value when the temperature changes. Thermistors are a type of variable resistors and widely used in various electronic components, such as temperature sensors, self-regulating heaters, etc. There are two main types of thermistors, a negative temperature coefficient (NTC) thermistor and a positive temperature coefficient (PTC) thermistor. The resistance of the positive temperature coefficient thermistor increases with increasing temperature, and the resistance of the negative temperature coefficient thermistor decreases with increasing temperature. Negative temperature coefficient thermistors (NTCs) are also commonly used as temperature sensing elements within circuits. If the sensor 123 uses a negative temperature coefficient thermistor (NTC), the following specifications may be applied:
1. NTC model: (TDK) B57332 V5103 F360;
2. NTC suitable operating temperature range: −40° C.˜150° C.;
3. NTC resistance value accuracy: ±1.0%;
4. Belongs to a surface mount device (SMD);
5. Resistance value at 25° C.=10000[Ω]±1.0%;
6. Comply with IATF 16949 standard.

FIG. 2A to FIG. 2D further illustrate the sensors 123 disposed in the non-thermal region 122. The sensor 123 is a sensing chip of a surface mount device (SMD), and is powered via the terminal 124. The heater 120 includes a sensor 123, and the sensor 123 is arranged in the non-thermal region 122 of the heater 120 away from the thermal zone 121 to advantageously reduce the influence of the thermal zone 121 on the sensor 123 and further reduces the influence of the thermal zone 121 on the sensed values (readings), or to prevent the sensor 123 from loosening or failure due to the influence of high temperature during a heating process. Meanwhile, the sensor 123 is electrically connected to the heating element 121A disposed in the thermal zone 121 to activate the heater 120, control the temperature of the thermal zone 121, and regulate the temperature difference between the thermal zone 121 and the non-thermal zone 122.

An external power supply device (not shown) may be electrically connected to the terminal 124 of the non-thermal zone 122 to provide the heating element 121A with the electric energy to be converted into heat energy. After the electrically connected sensor 123 activates the heater 120, the temperature of the thermal zone 121 rises rapidly, but the temperature of the non-thermal zone 122 rises slowly. In one embodiment of the present invention, the temperature difference between the thermal zone 121 and the non-thermal zone 122 of the heater 120 is not less than 40° C. after 1 minute when the power supply device initiates the heater. The temperature difference mentioned here is calculated by the difference between the highest temperature in the thermal zone 121 and the lowest temperature in the non-thermal zone 122, and the temperature difference is determined by the temperature sensing function of the sensor 123 with respect to the thermal zone 121 and to the non-thermal zone 122 to feed back to the power supply device. A larger temperature difference between the thermal zone 121 and the non-thermal zone 122 is conducive to quickly conduct the heat energy generated by the heating element 121A in the thermal zone 121 directly to the first outer lens element 111A in direct contact with the thermal zone 121, but the present invention is not limited thereto.

The outer surface of a general optical lens which is exposed to an external environment is prone to fogging, frosting or icing in cold regions or in a snowy winter, which results in blocking the field of view of the optical lens and makes it out of order. Please refer to FIG. 1, in another embodiment of the present invention, the temperature difference between the outer lens group 111 and the inner lens group 112 is not less than 20° C. after 1 minute when the sensor 123 controls the heater 120 to initiate it. The temperature difference mentioned here is the difference between the highest temperature in the outer lens group 111 and the lowest temperature in the inner lens group 112. The heated outer lens group 111 is conducive to quickly expel the moisture M on the outer lens group 111, for example, on the outer surface 111S of the first outer lens element 111A, and restore the imaging function of the imaging lens group 110, but the present invention is not limited thereto. The moisture M here represents any physical state, such as condensation, frost or icing of mist due to the three states of mass, such as solid, liquid, or gas.

FIG. 2E to FIG. 2H are schematic diagrams of some variant embodiments of the thermal zone and the non-thermal zone 122 of the heater 120 according to the present invention. In one embodiment of the present invention, at least two portions of the heater 120 may include a non-thermal zone 122 and a plurality of thermal zones. The thermal zones further include a plurality of heating elements 121A. For example, a non-thermal zone 122 is designed to be sandwiched between a plurality of thermal zones. Please refer to FIG. 2E, in a variant embodiment of the present invention, at least two portions of the heater 120 may include a first thermal zone 121R, a second thermal zone 121S, and the non-thermal zone 122. The shapes of the first thermal zone 121R and the second thermal zone 121S of the heater 120 may be a combination of an annular shape. The design of the resistors in the annular rings may be the same. Please refer to FIG. 2F, in another variant embodiment of the present invention, the shapes of the first thermal zone 121R and the second thermal zone 121S of the heater 120 may be a combination of an annular shape. The design of the resistors in the annular rings may be different. Please refer to FIG. 2G, in another variant embodiment of the present invention, the shapes of the first thermal zone 121R and the second thermal zone 121S of the heater 120 may be a combination of an annular shape and a double-crescent shape, and the design of the resistors in the annular ring may be optional, but the present invention is not limited to what is shown in FIG. 2G. Please refer to FIG. 2H, in another variant embodiment of the present invention, the shapes of the first thermal zone 121R and the second thermal zone 121S of the heater 120 may be a combination of a double-crescent shape.

Please continue to refer to FIG. 1, the lens barrel 130 is at least used to accommodate the inner lens group 112, accommodate the heating element 121A, or optionally further accommodate other outer lens elements other than the first outer lens element 111A in the outer lens group 111, such as a second outer lens element (not shown). The heating element 121A accommodated in the lens barrel 130 advantageously neither affects the appearance specification of the thermal lens set 100, nor affects the optical performance of the optical system where the imaging lens group 110 is located.

Optionally, the lens barrel 130 further includes a seal ring 140 if it is necessary to isolate the inner lens group 112 and the optional outer lens group 111 accommodated in the lens barrel 130 from the influence of the ambient environment, so that the lens groups in the lens barrel 130 are enclosed in the lens barrel 130 by the seal ring 140 to isolate the lens groups in the lens barrel 130 from the influence of the ambient environment. The seal ring 140 is disposed between the outer lens group 111 and the inner lens group 112. Or, the seal ring 140 may also be regarded as being disposed between the heating element 121A and the inner lens group 112. The seal ring 140 may be an O-ring made of an airtight material such as silicon or rubber. The outer diameter of the seal ring 140 may roughly correspond to the inner diameter of the lens barrel 130, so that the interior of the lens barrel 130 is in an airtight state to protect the lens groups in the lens barrel 130 in the presence of the seal ring 140.

In one embodiment of the present invention, the edge E of the lens groups in the lens barrel 130 engages with the inner diameter of the lens barrel 130 to fix each lens element. FIG. 1 shows that the first inner lens element 112A is taken as an example, and the edge E of the first inner lens element 112A engages with the inner diameter of the lens barrel 130, but the present invention is not limited thereto.

Please continue to refer to FIG. 1, the thermal lens set 100 of the present invention may further optionally include a cap 150. The cap 150 is used to accommodate and protect at least one outer lens element of the outer lens group 111, such as the first outer lens element 111A, so that the outer lens group 111 is sandwiched between the cap 150 and the heating element 121A of the thermal zone 121. In one embodiment of the present invention, the inner diameter of the cap 150 may roughly correspond to the outer diameter of the outer lens element of the outer lens group 111. Taking the first outer lens element 111A as an example, its edge E allows the first outer lens element 111A to be engaged with the cap 150 in order to protect the first outer lens element 111A.

In one embodiment of the present invention, the lens barrel 130 accommodates two of the at least two portions of the heater 120. For example, the heater 120 includes the heating element 121A and the sensor 123 which controls the heating element 121A, and the lens barrel 130 accommodates the two portions, i.e. the heating element 121A of the heater 120 and the sensor 123. Some possible examples of the lens barrel 130 to accommodate the sensor 123 are described below.

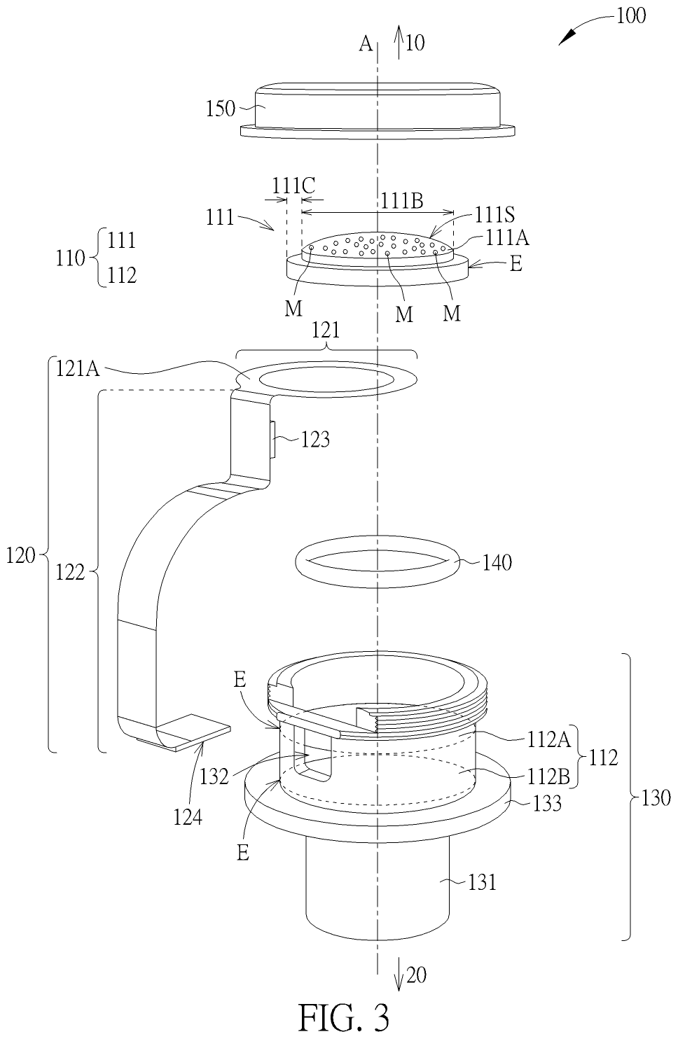

FIG. 3 illustrates an exploded view of components of a second embodiment of the thermal lens set 100 of the present invention. In the second embodiment of the present invention, the configuration and functions of the thermal lens set 100 are similar to the first embodiment of the present invention, so the details are not elaborated again. The lens barrel 130 includes a body 131, and the body 131 is equipped with a space 132. The position, size and depth of the space 132 correspond to the sensor 123 on the heater 120, so that the space 132 is suitable for accommodating the sensor 123. The sensor 123 is accommodated in the dedicated space 132 on the lens barrel 130, which is beneficial to reduce the overall volume of the thermal lens set 100.

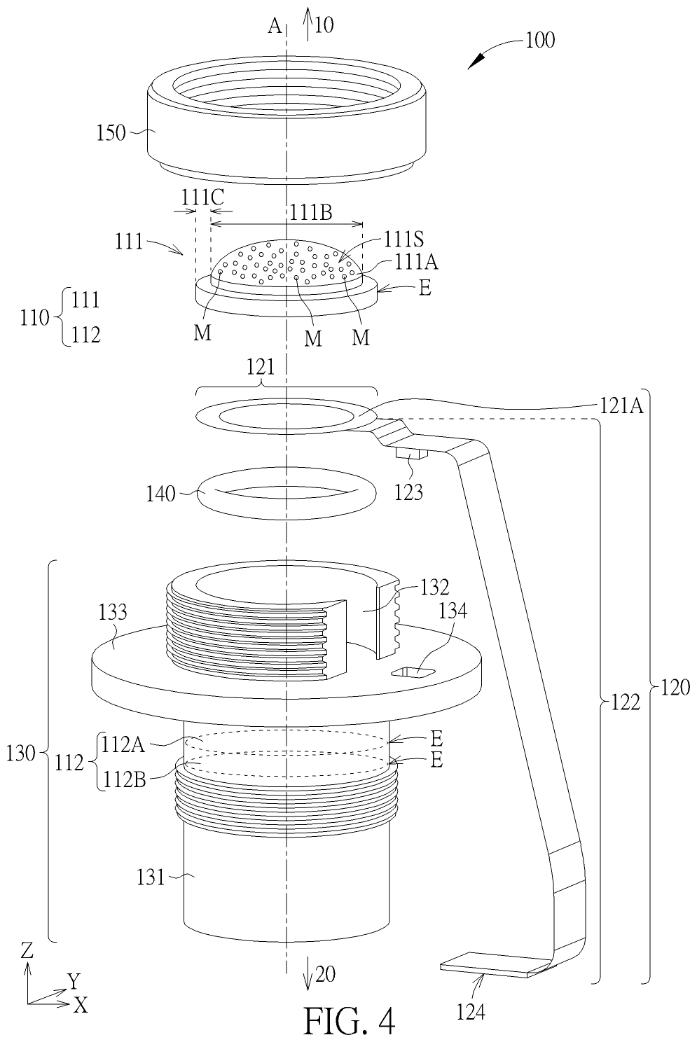

FIG. 4 illustrates an exploded view of components of a third embodiment of the thermal lens set 100 of the present invention. In the third embodiment of the present invention, the configuration and functions of the thermal lens set 100 are similar to the first embodiment of the present invention, so the details are not elaborated again. In addition to the body 131, the lens barrel 130 further includes a flange 133. The extending direction of the flange 133 is perpendicular to the extending direction of the body 131, that is, perpendicular to the extending direction of the optical axis A. For example, the body 131 and the optical axis A extend along a direction parallel to the Z axis, the flange 133 extends along a direction parallel to the X axis and to the Y axis, and the X axis, the Y axis, and the Z axis are perpendicular to one another. The flange 133 is equipped with a space 134. The position, size and depth of the space 134 correspond to the sensor 123 on the heater 120, so that the space 134 is suitable for accommodating the sensor 123. Optionally, the lens barrel 130 may be provided with the space 132 as well as with the space 134 respectively corresponding to the body 131 and to the flange 133, so that the sensor 123 may be optionally accommodated in the space 132 or in the space 134.

The present invention provides use of the thermal lens set 100 according to the thermal lens set 100 of the aforementioned different embodiments. First, the thermal lens set 100 as described above is provided. Please refer to the above for the details of the thermal lens set 100. Second, the external power supply (not shown) is electrically connected to the terminal 124 to activate the heater 120 via the sensor 123, so that the temperature of the thermal zone 121 rises rapidly. One minute after the heater 120 is activated, the temperature difference between the non-thermal zone 122 and the thermal zone 121 is no less than 40° C. The sensor 123 may control the heating rate of the heater 120. The temperature difference mentioned here is calculated by the difference between the highest temperature in the thermal zone 121 and the lowest temperature in the non-thermal zone 122, and the temperature difference is determined by the temperature sensing function of the sensor 123 with respect to the thermal zone 121 and to the non-thermal zone 122. A larger temperature difference between the thermal zone 121 and the non-thermal zone 122 is conducive to quickly conducting the heat energy generated by the heating element 121A in the thermal zone 121 directly to the first outer lens element 111A in direct contact with the thermal zone 121 but the present invention is not limited thereto so that the thermal lens set 100 of the present invention has the function of controlling the temperature difference between the thermal zone 121 and the non-thermal zone 122 through the sensor 123.

In cold regions or in a snowy winter, the outer surface of a general optical lens which is exposed to the external environment is prone to fogging, frosting or icing, which blocks the field of view of the optical lens and makes it out of order. Therefore, the present invention further provides an advantageous method of removing a mist from the lens set to maintain a good field of view of the optical lens set. First, the thermal lens set 100 as described above is provided. Please refer to the above for the details of the thermal lens set 100. The thermal zone 121 includes a heating element 121A. The heating element 121A is in direct contact with the outer lens group 111, such as the first outer lens element 111A, but the present invention is not limited thereto. On the outer surface 111S of the first outer lens element 111A, there may be moisture M which is condensed due to a temperature change. The moisture M here represents any physical state, such as condensation, frost, or icing of mist due to the three states of mass, such as solid, liquid, or gas.

Second, an external power supply device (not shown) is electrically connected to the terminal 124 to activate the heater 120 via the sensor 123, so that the temperature of the outer lens group 111 in direct contact with the heating element 121A begins to rise. The sensor 123 may control the heating rate of the heater 120. 1 minute after the heater 120 is activated, the heating element 121A of the present invention may make the temperature difference between the outer lens group 111 and the inner lens group 112 not less than 20° C. The temperature difference mentioned here is calculated by the difference between the highest temperature in the outer lens group 111 and the lowest temperature in the inner lens group 112, and the temperature difference is determined by the temperature sensing function of the sensor 123. The heated outer lens group 111 is conducive to at least partially, preferably completely, and rapidly removing the moisture M on the outer lens group 111, for example, on the outer surface 111S of the first outer lens element 111A to restore the imaging function of the imaging lens group 110, but the present invention is not limited thereto. The design of the outer lens group 111 in direct contact with the heating element 121A enables the thermal lens set 100 of the present invention to have the function of removing the moisture M which blocks the field of view of the thermal lens set 100 on the outer surface 111S through the heating element 121A.

The sensor in the thermal lens set provided by the present invention may be arranged in a non-thermal zone away from the thermal zone and electrically connected to the heating element. Such design not only prevents the sensor from being loosened or failed due to the influence of the heating process, but also the sensor may be accommodated in a dedicated space on the lens barrel, so the thermal zone is less easily to affect and interfere with the readings, the appearance specification of the thermal lens set is advantageously not affected, the optical performance of the optical system where the imaging lens group is located is not affected, and the overall volume of the thermal lens set may also be advantageously reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermal lens set, comprising:
an imaging lens set comprising an inner lens group and an outer lens group which comprises at least one outer lens element;
a heater to heat the imaging lens set and comprising at least two portions, wherein one of the at least two portions is in direct contact with the imaging lens set; and
a lens barrel to accommodate another one of the at least two portions.

2. The thermal lens set of claim 1, wherein the at least two portions of the heater comprise a non-thermal zone and a thermal zone with a heating element.

3. The thermal lens set of claim 2, wherein the at least one outer lens element is in direct contact with the heating element.

4. The thermal lens set of claim 2, wherein the inner lens group comprises a plurality of inner lens elements and the heating element is disposed between the outer lens group and the inner lens group.

5. The thermal lens set of claim 2, wherein a shape of the thermal zone is selected from a group consisting of an annular shape and a crescent shape.

6. The thermal lens set of claim 1, wherein the at least two portions of the heater comprises a plurality of thermal zones comprising a plurality of heating elements.

7. The thermal lens set of claim 2, further comprising:
a sensor disposed in the non-thermal zone and electrically connected to the heating element.

8. The thermal lens set of claim 7, wherein the lens barrel comprises a body comprising a space to accommodate the sensor.

9. The thermal lens set of claim 7, wherein the lens barrel comprises a flange comprising a space to accommodate the sensor.

10. The thermal lens set of claim 1, wherein the lens barrel comprises a seal ring disposed between the outer lens group and the inner lens group.

11. The thermal lens set of claim 2, wherein the lens barrel comprises a seal ring disposed between the heating element and the inner lens group.

12. The thermal lens set of claim 1, further comprising:
a cap to accommodate the at least one outer lens element.

13. The thermal lens set of claim 7, wherein the sensor is a thermal-sensitive resistor.

14. The thermal lens set of claim 7, wherein the sensor is a surface mount device (SMD).

15. The thermal lens set of claim 2, wherein the heating element has an outer diameter D1 and an inner diameter D2, and (D1−D2)/2≥0.8 mm.

16. The thermal lens set of claim 2, wherein a temperature difference between the thermal zone and the non-thermal zone is not less than 40° C. after 1 minute of activating the heating element.

17. The thermal lens set of claim 3, wherein a temperature difference between the outer lens group and the inner lens group is not less than 20° C. after 1 minute of activating the heating element.

18. Use of a thermal lens set, comprising:
providing a thermal lens set of claim 1, wherein the heater comprises a non-thermal zone and a thermal zone with a heating element; and
activating the heater so that a temperature difference between the non-thermal zone and the thermal zone is not less than 40° C. after 1 minute of activating the heating element.

19. A method to remove a mist from a lens set, comprising:
providing a thermal lens set of claim 1, wherein the heater comprises a non-thermal zone and a thermal zone which comprises a heating element in direct contact with the outer lens group which has a mist thereon; and
activating the heater so that a temperature difference between the outer lens group and the inner lens group is not less than 20° C. after 1 minute of activating the heater to at least partially remove the mist.

20. The method to remove a mist from a lens set of claim 19, wherein the heater comprises a sensor and the lens barrel comprises a space to accommodate the sensor which determines the temperature difference.
